(19) United States
(12) Patent Application Publication
(10) Pub. No.: US 2008/0052155 A1
(43) Pub. Date: Feb. 28, 2008

(54) Method and system of campaign management with code

(76) Inventors: Abdelkarim Tafferant, Utrecht (NL); Jean-Marie Ongenyi, Fontenay-Sous-Bois (FR)

Correspondence Address: MR. A. TAFFERANT, BLAUWKAPELSEWEG 29 bis, UTRECHT, 3572 KB, omitted

(21) Appl. No.: 11/510,292

(22) Filed: Aug. 28, 2006

(51) Int. Cl. G06Q 30/00

(52) U.S. Cl. 705/14

(57) ABSTRACT

The invention concerns a method and system of campaign management with code to define, to plan, to carry out, and to track, every steps of any multimedia campaign, over different media, based on different communication networks, notably the fix and mobile telecommunication networks, the Internet network, the telebroadcasting network as well as the radiobroadcasting network.

The invention forecasts that those steps and operations are carried out real time and end to end, in such a manner that there is no break of real time tracking.

The invention forecast also to generate every possible statistics related to campaigns, and to display them over different medias.

The invention forecast besides to carry out simultaneously several campaigns whether they are aimed at the same users or not.

### BACKGROUND OF THE INVENTION

1. Field of the Invention

The invention concerns a method and system with code enabling to define, to plan, to carry out, and to track, possibly real time, every phases and steps any multimedia campaign can go through, that is to say operated over different types of media, based on different communication networks, notably the fix and mobile telecommunication networks, the Internet network, tele broadcasting networks such as TV and radio broadcasting networks.

Besides, this method and system with code enables to display, possibly real time, over different systems a set of statistics related to the campaign.

The term <<campaign>> is commonly defined as a set of operations, possibly repeated, carried out on the basis of a prepared program, possibly during a certain time previously determined, following a precise aim and supported by communication operations.

For instance, it can concern a communication or advertising campaign operated by or for a company in order for instance to promote a new product.

It can also deal with, for instance, and non restrictively, the following types of campaigns:

Sales and marketing campaigns

Promotional campaigns

Booking campaigns

Recruitment campaigns

Voting campaigns

Vaccination campaigns

2. Description of the Related Art

Present systems that enable to operate campaigns face many limits and not solved objects:

Indeed, certain systems are devised to operate campaigns over only one media, for instance over the Internet media, called e-mailing campaign, or over the fix phone, called telemarketing campaign. Therefore, in such cases of monomedia campaign, the number of addressed persons is at least limited by, for instance, the equipment rate of the regarded media.

Besides, most systems present the drawback of not integrating and consequently of not being able to execute every steps of a campaign. For example, in many campaigns enabling the exercise of a discount coupon, the step of users authentication rarely exists, consequently all the information and statistics that could have been generated from the existence of that step can not be known and exploited.

Those systems often present the drawback of not being able to offer an end to end tracking of the campaign, when a tracking exists, that is to say that every steps operated by those systems are not tracked, and as a result the statistics that could have been generated from an end to end tracking of the campaign is just not available:

For example, in the case of present systems enabling to operate a campaign over mobile phones by SMS (Short Message Service), for example, most of the time only the step of transmission of the regarded SMS is tracked, so that the only available information, communicated by mobile telecommunication operators, is the number of SMS that was actually delivered. De facto, available statistics are limited.

Other systems are limited in so far as they can not offer a real time tracking of the campaigns they operate. Therefore, that does not permit to generate and to display real time the statistics related to the campaign.

Many other systems combine the limits described above. Indeed, for instance, if we consider certain systems enabling to operate an e-mails sending campaign, for example, of discount coupons to use on the purchase of a given product, on a given selling point, the person of that selling point in charge of operating the transaction with the regarded discount, most of the time, puts on the side the discount coupons, that will be processed only at the end of the day or within the next days. In that case, not only does the users authentication step not exist most of the time, but there also exists a break of the real time tracking of the campaign when the regarded coupons are used.

### SUMMARY OF THE INVENTION

The present invention solves the aforementioned limits met in most of today's campaigns, by resorting to the modeling described hereafter, which can apply to any campaign

Any campaign, as defined previously, comprises three fundamental parameters that are:
The recipient of the campaign called in the present invention <<the campaign user>> or <<the user>>. This parameter answers the question: who does the campaign apply to? Or who are the targets of the campaign? This parameter “user” can designate a person or a group of persons such as for instance a community composed of the members of an association.
The product(s)/service(s) consumable or usable by the campaign user, called in the present invention <<the product/service>>.
The campaign itself defined as a set of operations to carry out for the account of an orderer, for instance a commercial company, which applies to users, and dealing with one or several product(s)/service(s), called in the present invention the <<campaign>>.

The parameter <<campaign>> is a function of the parameters <<campaign user>> and <<product/service>>.
Those three parameters can therefore constitute a triplet under the form (X, Y, Z) where:
X corresponds to the parameter <<campaign user>>,
Y corresponds to the parameter <<product/service>>,
Z corresponds to the parameter <<campaign>>, where Z is a function of X and Y.

Each of those three parameters can take different values.

Indeed, X, Y and Z, can, respectively, and precisely designate any campaign user, any product/service, and any campaign.

In any campaign, there may consequently exist a certain integer of unique triplets with the form (value of the parameter user, value of the parameter product/service, value of the parameter campaign).

Those unique triplets all together correspond to every combinations resulting from the change of value of at least one of the three parameters.

For instance, if we consider a campaign, C1, wherein a commercial company offers to its two major customers, Person 1 and Person 2, a discount on their next purchase of product, P, then in that campaign two unique triplets exist, that are:
(Person 1, product P, campaign C1), and
(Person 2, product P, campaign C1).

Another example may be a city hall that offers the members of two sport clubs, Club 1 and Club 2, a discount on their next purchase of a product, P, then in that campaign two unique triplets exist, that are:
(Club 1, product P, campaign C1), and
(Club 2, product P, campaign C1).

In that last example, the parameter <<user>> does not designate an individual person but a group of persons, the members of each Club.

The innovation of the present invention resides, first and partly, in the fact that it models any campaign in a process of steps through which evolve different unique triplets with the form (value of the parameter user, value of the parameter product/service, value of the parameter campaign), to which are associated different unique codes in such a manner that any unique code corresponds to any unique triplet.

Moreover, a campaign can generally comprise the following phases:
A definition and planning phase of the campaign, that aims at initializing that latter in the respect of the proper parameters of each campaign such as for instance the campaign period, and at registering the campaign users.
A phase during which the campaign is carried out, phase that may comprise the following steps:
The transmission to users of the object of the campaign (for instance a discount on the next purchase of a given product)
The authentication of the campaign users, before those ones exercise the object of the campaign
The exercise of the object of the campaign by users
A phase of campaign analysis.

Given the fact that any campaign can be modeled by the present invention as a process of steps through which evolve a certain integer of unique triplets, and that a unique code is associated to each unique triplet, being able to track end to end and real time the steps through which evolve those unique codes amounts therefore to being able to track end to end and real time the steps of each campaign.

This is what the present invention enables by associating to each unique triplet a unique code, a digital element that can be tracked end to end and real time, no matter the types of networks and terminals the campaign is carried out over.

The invention concerns also the system enabling to implement the method associating a unique code to each unique triplet with the form (value of the parameter user, value of the parameter product/service, value of the parameter campaign), with all its variants.

### BRIEF DESCRIPTION OF THE SEVERAL VIEWS OF THE DRAWING

FIG. 1 is a drawing illustrating schematically the steps carried out by the campaign manager with code;

FIG. 2 is a drawing illustrating schematically the step of users registering with the various registering systems;

FIG. 3 is a drawing illustrating schematically the step of codes transmission with the various receiving systems;

FIG. 4 is a drawing illustrating schematically the step of codes exercise with the various exercise systems;

FIG. 5 is a drawing illustrating schematically the step of tracking and statistics with the various systems enabling to receive and display those statistics.

### DETAILED DESCRIPTION OF THE INVENTION

The problems involved in the prior art are removed in the present invention thanks to a method of campaign management with code that is able to define, to plan, to carry out, over different medias, based on different communication networks, notably the fix and mobile telecommunication networks, the Internet network, TV broadcasting networks and radio broadcasting networks, the steps of any campaign, and to track all those steps in such a manner that there may not exist any tracking break, and consequently to generate every possible statistics displayable over different medias, characterized by the fact that it comprises the following steps, carried out by a campaign manager, called in this present invention “campaign manager with code”:
the initialization of the parameters related to the campaigns (period of the campaign, conditions to meet to benefit from the campaign . . . )
the creation of unique codes associated to each unique triplet of campaigns
the codes transmission toward the users of the campaigns
the exercise of those codes

Advantageously and preferably, the present method comprises a step that enables the registering of the campaign users.

Advantageously and preferably, the present method also comprises a step that enables the users of the campaign not to be registered anymore.

Advantageously and preferably, the present method also comprises a step that enables the codes authentication.

Advantageously and preferably, the present method also comprises a step that enables the codes tracking.

Advantageously and preferably, the present method also comprises a step that enables to generate statistics related to campaigns.

Advantageously and preferably, the present method also comprises a step that enables to display those statistics over different medias.

The present invention also comprises notably a method wherein the aforementioned steps and operations are carried out end to end, that is to say all of them are carried out.

According to one particularity of the invention, such a method enables a tracking of all steps of any campaign, which means an end to end tracking, in such a manner that there is no break tracking, and consequently enables to generate every possible statistics that are displayable over different medias.

The present invention also comprises a method enabling to carry out simultaneously several campaigns whether they are aimed at the same users or not.

The present invention also comprises a method wherein the aforementioned steps and operations are carried out real time.

The aforementioned barriers present systems bump into are also suppressed, according to the present invention, thanks to a campaign management system, called in this present invention “a campaign management system with code”, characterized by the fact that it comprises a campaign manager with code, and also comprises:
means to initialize parameters related to the campaigns (campaign period, conditions to satisfy to benefit from the campaign . . . ), possibly real time
means to create the unique codes associated to each unique triplet campaigns, possibly real time
means to transmit those codes toward the users of the campaigns, possibly real time
means to exercise those codes, possibly real time
possibly, means to register campaigns users, possibly real time
possibly, means to make campaigns users not registered anymore, possibly real time
possibly, means to authenticate those codes, possibly real time
possibly, means to track those codes, possibly real time
possibly, means to generate statistics, possibly real time
possibly, means to display those statistics, possibly real time
possibly, means to carry out end to end steps and operations of the method
possibly, means to track every steps and operations of the method, possibly real time
possibly, means to carry out simultaneously several campaigns whether they are aimed at the same users or not.

According to one particularity of the invention, this system comprises a database connected to the campaign manager with code, containing particularly information that are specific to the campaign such as the campaign parameters, information related to the user profile, information related to the product(s)/service(s) of the campaign, information related to codes.

The present invention solves the aforementioned limits met in most of today's campaigns, by resorting to the modeling described hereafter, which can apply to any campaign

Any campaign, as defined previously, comprises three fundamental parameters that are:
The recipient of the campaign called in the present invention <<the campaign user>> or <<the user>>. This parameter answers the question: who does the campaign apply to? Or who are the targets of the campaign? This parameter “user” can designate a person or a group of persons such as for instance a community composed of the members of a club, an association.
The product(s)/service(s) consumable or usable by the campaign user, called in the present invention <<the product/service>>.
The campaign itself defined as a set of operations to carry out for the account of an orderer, for instance a commercial company, which applies to users, and dealing with one or several product(s)/service(s), called in the present invention the <<campaign>>.

The parameter <<campaign>> is a function of the parameters <<campaign user>> and <<product/service>>.

Those three parameters can therefore constitute a triplet under the form (X, Y, Z) where:
X corresponds to the parameter <<campaign user>>,
Y corresponds to the parameter <<product/service>>,
Z corresponds to the parameter <<campaign>>, where Z is a function of X and Y.

Each of those three parameters can take different values.

Indeed, X, Y and Z, can, respectively, and precisely designate any campaign user, any product/service, and any campaign.

In any campaign, there may consequently exist a certain integer of unique triplets with the form (value of the parameter user, value of the parameter product/service, value of the parameter campaign).

Those unique triplets all together correspond to every combinations resulting from the change of value of at least one of the three parameters.

For instance, if we consider a campaign, C1, wherein a commercial company offers to its two major customers, Person 1 and Person 2, a discount on their next purchase of product, P, then in that campaign two unique triplets exist, that are:
(Person 1, product P, campaign C1), and
(Person 2, product P, campaign C1).

Another example may be a city hall that offers the members of two sport clubs, Club 1 and Club 2, a discount on their next purchase of a product, P, then in that campaign two unique triplets exist, that are:
(Club 1, product P, campaign C1), and
(Club 2, product P, campaign C1).

In that last example, the parameter <<user>> does not designate an individual person but a group of persons, the members of each Club.

The innovation of the present invention resides, first and partly, in the fact that it models any campaign in a process of steps through which evolve different unique triplets with the form (value of the parameter user, value of the parameter product/service, value of the parameter campaign), to which are associated different unique codes in such a manner that any unique code corresponds to any unique triplet.

Moreover, a campaign can generally comprise the following phases:
A definition and planning phase of the campaign, that aims at initializing that latter in the respect of the proper parameters of each campaign such as for instance the campaign period, and at registering the campaign users.
A phase during which the campaign is carried out, phase that may comprise the following steps:
   The transmission to users of the object of the campaign (for instance a discount on the next purchase of a given product)
   The authentication of the campaign users, before those ones exercise the object of the campaign
   The exercise of the object of the campaign by users
A phase of campaign analysis.

Given the fact that any campaign can be modeled by the present invention as a process of steps through which evolve a certain integer of unique triplets, and that a unique code is associated to each unique triplet, being able to track end to end and real time the steps through which evolve those unique codes amounts therefore to being able to track end to end and real time the steps of each campaign.

This is what the present invention enables by associating to each unique triplet a unique code, a digital element that can be tracked end to end and real time, no matter the types of networks and terminals the campaign is carried out over.

The invention concerns also the system enabling to implement the method associating a unique code to each unique triplet with the form (value of the parameter user, value of the parameter product/service, value of the parameter campaign), with all its variants.

The step of the campaign users registering, when it exists, aims at obtaining the explicit agreement of the users who will benefit from the campaign, then at least one information enabling to identify each of them uniquely, and at least one information concerning the address of the receiving system(s) on which they wish to receive the message(s) of the campaign. This step is carried out in the respect of conditions of the campaign, parameterized within the campaign manager with code.

The information enabling to identify each user as unique can advantageously be:
A phone number, whether it is a mobile or fix phone number
His or her name and firstname
An electronic address such as an e-mail address
Any code, for instance an alphanumerical code, which identifies each user and which may stem from different sources. That unique code may notably stem from a loyalty program club, or from any other organization, or being generated by the campaign manager with code
An electronic address corresponding to a terminal connected to a digital TV broadcasting network, such as for instance a digital TV set of the user
An electronic address corresponding to a terminal connected to a digital radio broadcasting network, such as for instance a digital radio set of the user
Biometrics identification elements such as the fingerprint, the hand geometry, the face geometry, the voice, the iris, the retina, or the dynamic signature
The national health security number of the user
An identification number stemming from any statistics or economic studies institute
Any unique bar code, generated or not by the campaign manager with code

On top of the aforementioned elements, the information enabling to identify each user as unique can be:
Any unique picture, corresponding for instance to a photograph of the user
Any unique sound suite
Any unique moving pictures suite, corresponding for instance to a video clip or a cartoon
Any unique combination of the above elements

On top of the aforementioned elements, the information enabling to identify as unique the user when it designates for instance a group of persons can be:
The name of this group
A proper feature of that group such as for instance the fact that these group's members belong to a specific age group, or live in a specific geographic area
the name of an electronic broadcast list, that contains the electronic addresses of these group's members

The explicit agreement from the users can be obtained by the trademark or the organization for which the campaign is carried out, which registers at least an information enabling to identify each user as unique, and at least one information concerning the address of the receiving system(s) of the users on which the campaign manager with code will transmit codes. Those data are then integrated within the campaign manager with code, for instance under the form of an electronic file or not.

According to one particularity of the invention, that step aiming at obtaining the explicit agreement of users and at least an information enabling to identify each user as unique, can also be operated directly by the campaign manager with code through the following process:

After having let potential users know of the existence of a campaign, through an on line invitation, for instance on a web site banner, or an off line invitation, for instance on a bill or a paper advertising, interested people can register themselves for the regarded campaign services through different systems that will supply the campaign manager with code with the following information:
their registering, through that their explicit agreement
at least an information enabling to identify each user as unique
at least one information corresponding to the address of the receiving system(s) of the users on which the campaign manager with code will transmit codes as defined previously.

The different systems enabling the users registering, and connected to the campaign manager with code can be:
a voice server
a terminal connected to the Internet network
a mobile terminal
a terminal connected to a digital TV broadcasting network
a terminal connected to a digital radio broadcasting network
an interactive terminal
a system of capture and processing of morphological or biometrics elements, coupled to one of the above systems

According to one particularity of the invention, the step of registering can be operated by voice recognition by any system provided with such a functionality, as for instance a voice server or a computer.

In the case of a voice server, connected to the campaign manager with code, interested people can register themselves by supplying with at least one information corresponding to the address of their receiving system(s) on which the campaign manager with code will transmit codes, preferably, their mobile or fix phone number, and one information, for instance a numerical one, that identifies each of them as unique, which may stem from different sources, such as for instance a loyalty program club, or any other organization.

In the case of a terminal connected to the Internet network, interested people can register themselves by filling in a registering form with at least one information corresponding to the address of their receiving system(s) on which the campaign manager with code will transmit codes, preferably, their mobile or fix phone number, and one information, for instance a numerical one, that identifies each of them as unique, which may stem from different sources, such as for instance a loyalty program club, or any other organization. That form can be reached from a dedicated web page connected to the campaign manager with code.

In the case of a mobile terminal, for instance a WAP mobile (Wireless Application Protocol) or a GPRS one (General Packet Radio Services) or a UMTS one (Universal Mobile Telecommunications System), interested people can register themselves by filling in a registering form with at least one information corresponding to the address of their receiving system(s) on which the campaign manager with code will transmit codes, and one information, for instance a numerical one, that identifies each of them as unique, which may stem from different sources, such as for instance a loyalty program club, or any other organization. That form can be reached from a dedicated web page, under a format adapted to the type of terminal, connected to the campaign manager with code.

In the case of a mobile terminal, interested people can register themselves with specific SMS or MMS sent to the campaign manager with code, with at least one information corresponding to the address of their receiving system(s) on which the campaign manager with code will transmit codes, and one information, for instance a numerical one, that identifies each of them as unique, which may stem from different sources, such as for instance a loyalty program club, or any other organization.

In the case of a terminal connected to a digital TV broadcasting network, interested people can register themselves by filling in a registering form, with at least one information corresponding to the address of their receiving system(s) on which the campaign manager with code will transmit codes, and one information, for instance a numerical one, that identifies each of them uniquely, which may stem from different sources, such as for instance a loyalty program club, or any other organization. The digital TV broadcasting network then sends registered data to the campaign manager with code.

In the case of a terminal connected to a digital radio broadcasting network, interested people can register themselves by filling in a registering form, with at least one information corresponding to the address of their receiving system(s) on which the campaign manager with code will transmit codes, and one information, for instance a numerical one, that identifies each of them as unique, which may stem from different sources, such as for instance a loyalty program club, or any other organization. The digital radio broadcasting network then sends registered data to the campaign manager with code.

In the case of a system of capture and processing of morphological or biometrics elements, for instance of fingerprint, interested people can register themselves by putting their finger on an ad hoc reader that digitizes that fingerprint, processes it and transmits it to the campaign manager with code. Thus, at least one information that identifies each user as unique is registered in the campaign manager with code. Then, the registering of at least one information corresponding to the address of the users' receiving system(s) on which the campaign manager with code will transmit codes continues over one of the different registering means of that information.

In the present invention, under interactive terminal is meant a multimedia equipment that may be composed of a voice server, a terminal connected to the Internet network, a terminal connected to a digital TV broadcasting network, a terminal connected to a digital radio broadcasting network, a system of capture and processing of morphological or biometrics elements, or an optic reader.

This interactive terminal can be for instance located in a place belonging to the company for which the campaign is carried out, connected to the campaign manager with code. Interested people can register themselves by filling in a registering form adapted to the interactive terminal, with at least one information corresponding to the address of their receiving system(s) on which the campaign manager with code will transmit codes, and one information, for instance a numeric one, that identifies each of them uniquely, which may stem from different sources, such as for instance a loyalty program club, or any other organization. Registered data are then sent by the interactive terminal to the campaign manager with code.

The piece of information enabling to identify any user as unique can be the same as the address of the user receiving system(s) on which the campaign manager with code will transmit codes. This is for instance the case with a phone number. In that case, the obtaining of the explicit agreement and the address of the user receiving system(s) on which the campaign manager with code will transmit codes are sufficient to operate this registering step.

Since the registering step of the campaigns users is accomplished, the “user” element of the triplet (campaign user, product/service, campaign) is now known from the campaign manager with code.

Advantageously, for any reason, any registered user who would not wish any more to benefit from campaigns services, can at any time ask for his unsubscribing through any system used for the registering. Any unsubscribing is processed by the campaign manager with code.

Besides, certain parameters related to the user profile, such as for example the kind of terminal the user wishes to receive a campaign communication, are configurable by himself/herself, for instance, trough the following systems
a voice server
a terminal connected to the Internet network
a mobile terminal
a terminal connected to a digital TV broadcasting network
a terminal connected to a digital radio broadcasting network
an interactive terminal

These user data are processed by the campaign manager with code, which updates them in the database that contains specific information of the campaign.

The invention concerns also the system enabling to operate the step of the above described method, with all its variants.

The step of code creation consists in creating at least unique codes enabling to identify each unique triplet as defined previously. This step is carried out in the respect of conditions of the campaign configured within the campaign manager with code.

Other possible codes that will identify as unique not each triplet but the value of only one of its three parameters regarded independently may also be created. For instance, the campaign manager with code will also be able to create a unique code enabling to identify a given user as unique. That code may be useful, for instance, during the authentication step, when that step exists, if before benefiting from the object of the campaign, it is foreseen to authenticate the user. In such a case, it will be possible to ask the user first his/her user code then his/her triplet code.

The information enabling to identify as unique the campaign can advantageously be any unique alphanumerical code, created by the campaign manager with code. That information identifies as unique a precise campaign.

According to another particularity of the campaign, the information enabling to identify as unique the campaign can be:
any unique picture, corresponding for instance to the logo of a trademark
any unique sound suite
any unique moving pictures suite, corresponding for instance to a video clip or a cartoon
any unique combination of the above elements
any unique bar code, created or not by the campaign manager with code

The information enabling to identify as unique the product/service can advantageously be:
any unique alphanumerical code, that can notably be any type of code corresponding to an international or not codification standard, such as for instance the different types of EAN codes (efficient article numbering). That alphanumerical code can be created by the campaign manager with code
any bar code of products/services codification, such as for instance the different types of EAN symbol (efficient article numbering)
the name of the product/service
any unique picture, corresponding for instance to a product/service, to a company logo, to an “égérie” or muse . . .
any unique sound suite, corresponding for instance to one of the jingles of a company, a product/service
any unique moving pictures suite, corresponding for instance to a video clip or a cartoon
any unique combination of the above elements

That information enabling to identify as unique the product/service can stem from different sources, one of which is the campaign manager with code.

The unique code enabling to identify as unique each triplet composed of the information concerning the targeted user, the regarded campaign and the proposed product/service can advantageously be:
any unique alphanumerical code
any unique bar code

According to one particularity of the invention, the unique code enabling to identify as unique each triplet can also be:
any unique picture
any unique sound suite
any unique moving pictures suite, corresponding for instance to a video clip or a cartoon
any unique combination of the above elements

The creation of unique codes, whether they are codes enabling to identify as unique each triplet, or the ones enabling to identify as unique users, or the ones enabling to identify as unique campaigns, or the ones enabling to identify as unique products/services, can be for instance operated by a random generation function of alphanumeric codes. Those codes are stored in the database that contains specific information of the campaign.

According to one particularity of the invention, the campaign manager with code will make sure the codes it creates are not identical to existing code of the same type (four types of code can exist). That means that:
codes enabling to identify as unique each unique triplet are different with one another
codes enabling to identify as unique each user are different with one another
codes enabling to identify as unique each campaign are different with one another
codes enabling to identify as unique each product/service are different with one another

In the opposite case, for each type of code, one or several new codes generations are automatically operated till the obtaining of a different code of any existing generated code.

Cases may exist where, for instance, if there are no campaigns carried out simultaneously, and if those campaigns include identical users, then codes enabling to identify as unique each user, if they exist, are sufficient to carry out those campaigns. In those cases, we consider that to the unique triplets are associated unique codes that can be the same codes as the ones enabling to identify as unique each user. Those codes can be generated or not by the campaign manager with code.

The invention also concerns the system enabling to carry out the step of the method described above, with all its variants.

The step of codes transmission consists in transmitting to the concerned users through different broadcasting means, a message composed of different elements with always at least one code such as the ones created in the previous step of codes creation, enabling to identify as unique each unique triplet composed of the information concerning the targeted user, the regarded campaign and the product/service. Those messages are received by users through different receiving means. That step is carried out in the respect of conditions of the campaign, parameterized within the campaign manager with code.

Besides the code, possible other elements of the message can precise the campaign, or customize the message alluding to one or several proper characteristics of the user, such as, for instance, his/her name, firstname, birthday, or even address in order to for instance invite him/her to benefit from a discount on the closest selling point.

According to one particularity of the invention, possible other elements of the message besides the code enabling to identify as unique each unique triplet composed of the information concerning the targeted user, the regarded campaign and the product/service can also be:
any unique picture
any unique sound suite, corresponding for instance to the jingle of a brand
any unique moving pictures suite, corresponding for instance to a video clip or a cartoon
any unique combination of the above elements
possible other codes generated by the campaign manager with code enabling to identify as unique the targeted user, the regarded campaign or the product/service

Transmission means of messages to the concerned users can be:
A mobile telecommunication network to transmit messages whether they are vocal type, SMS type, multimedia type (combination of text, sounds, pictures, video . . . ) such as MMS or EMS (Enhanced Messaging Services), or e-mail type. Resorted norms for such a transmission can be GSM type (Global Standard for Mobile Communications), WAP type—in that case it is possible to transmit messages under the WML format—, GPRS, UMTS . . . Possible transmission terminals of that type of messages can be any type of mobile terminal (mobile phone, personal assistant such as PDA, laptop . . . ) or any transmission system of message under the form of SMS or multimedia such as a GSM, GPRS or UMTS modem, as long as they are connected to a mobile telecommunication network.
A fix telecommunication network to transmit messages under the form of text or picture sent by a fax, or vocal type sent by a voice server or an automaton that sends outbound calls or a call center.
The Internet network to transmit for instance multimedia messages for example under the form of an HTML page (HyperText Markup Language).
An electronic mail system to transmit e-mail messages, that can be under the form of an HTML page.
A digital TV broadcasting network to transmit for instance multimedia messages.
A digital radio broadcasting network to transmit for instance sound or text type messages.
A postal network to transmit for instance paper type messages.

Means of messages receiving can be:
When messages are sent from a mobile telecommunication network, receiving terminals can be any type of mobile terminal (mobile phone, personal assistant such as PDA, laptop . . . ) such as GSM, WAP—in that case it is possible to receive messages under the form WML (Wireless Markup Language)—, GPRS, UMTS.
When messages are sent from a fix telecommunication network, receiving terminals can be any type of mobile terminal able to receive vocal messages, as fix phone terminal of the user for example, as any fax terminal.
When messages are sent from the Internet network, receiving terminals can be any Personal Computer or mobile terminal as described above.
When messages are sent from an electronic mail system, receiving terminals can be any PC or mobile terminal as described above.
When messages are sent from a digital TV broadcasting network, receiving terminals can be any type of digital terminal such as, for instance, a digital TV set.
When messages are sent from a digital radio broadcasting network, receiving terminals can be any type of digital terminal such as, for instance, a digital radio set
When messages are sent from a postal network, receiving terminals can be any physical box mail of the user.
When messages are sent from a mobile telecommunication network, or a from a fix telecommunication network, or from the Internet network, or from a digital TV broadcasting network, or from a digital radio broadcasting network, receiving terminals can be any interactive terminal as defined previously.

According to one particularity of the invention, a given transmission system can transmit messages to a different receiving system. For example, an e-mail transmission from a mobile telecommunication network can be operated toward a personal computer using the Internet network.

According to another particularity of the invention, and advantageously, the transmission over the mobile telecommunication network of MMS type messages containing codes, is always accompanied of, on the one hand, the transmission of the same message on the Internet electronic or mobile Internet mailbox of the user, provided that the campaign manager with code knows the electronic address of the user, and/or over a dedicated web page, and on the other hand, within that MMS of a text part inviting the user to consult his/her electronic mailbox and/or the regarded dedicated web page.

Besides, the norms and formats used by the transmission systems adapt themselves to the nature of receiving systems. For example, for a receiving system composed of a WAP type mobile phone, messages sent by a transmission system can be under the WML format.

The invention concerns also the system enabling to operate the step of the above described method, with all its variants.

The step of codes authentication, if it exists, consists in authenticating codes transmitted to the campaign users during the previous step, over one of the authentication systems. This step is carried out in the respect of conditions of the campaign parameterized within the campaign manager with code.

This authentication step is composed of three phases that are:
the identification of at least codes enabling to identify each unique triplet
the checking of the valid/non valid feature of codes, in the respect of parameterized conditions for the regarded campaign, that is to say the checking of the fact that a given campaign for a given product/service exists for a given user
the notification of the valid/non valid feature of codes in the respect of parameterized conditions

According to one particularity of the invention, the campaign manager with code can prevent codes exercise, if those have not been identified, or if their non-valid feature has been checked, or if their non-valid feature has been notified.

Nonetheless, according to one particularity of the invention and advantageously, the system can first identify the user, that is to say to make sure the regarded person is actually a targeted user by the campaign.

Second, the system authenticates the code, that is to say it makes sure that a given campaign for a given product/service corresponds to the recipient of the message authenticated above.

According to one particularity of the invention, the authentication step can be carried out by voice recognition by any system that integrates such a functionality such as a voice server.

The codes and user authentication, when the user authentication exists, can be operated in two ways:
by a person different from the user (for example by an hostess within a store, a mall . . . )
by the user himself

In the case of an authentication operated by a person different from the user, that person can first enter in the campaign manager with code one of the elements that identify as unique the regarded user. Those elements are precised in the code creation step. This authentication can be operated resorting to different possible systems that can be:
a voice server
a terminal connected to the Internet network
a mobile terminal
an optic reader
an interactive terminal
a system of capture and processing of morphological or biometrics elements

In the case of a voice server, the person responsible for the authentication interrogates a voice server connected to the campaign manager with code, through a dedicated access, by informing it about one of the elements that identifies the user. Advantageously that informed element can be the mobile phone number of the user, entered from a fix or mobile phone terminal. Then the campaign manager with code processes that request by checking in the database, that contains specific information of the campaign, for example, that the entered mobile phone number corresponds actually to a possible recipient of the message. Then the campaign manager with code transmits to the voice server the result of that request. If that latter is negative, the voice server indicates the user could not be identified.

If the result of that request is positive, the voice server asks to enter the code received by the user. Then the campaign manager with code processes that request by checking, in the database that contains specific information of the campaign, that the code actually corresponds to a unique triplet (user, campaign, product/service), that is to say that a given campaign for a given product/service exists for the identified user.

Depending on the result of that process, the voice server confirms or infirms, with a vocal message, the validity of the unique triplet (user, campaign, product/service).

In the case of a terminal connected to the Internet network, the person responsible for the authentication gets to a dedicated web page connected to the campaign manager with code where there can be a form to be filled in with at least one of the elements that identifies the user, and with the code received by the user.

Then the campaign manager with code processes that request by checking, in the database that contains specific information of the campaign, that the code actually corresponds to a unique triplet (user, campaign, product/service), that is to say that a given campaign for a given product/service exists for the regarded user.

Depending on the result of that process, a notification stemming from an Internet server confirms or infirms the validity of the unique code.

In the case of a terminal connected to the Internet network, many advantages exist:
Given the fact that the form displayable via the Internet network can contain all available information of the user associated to the code, the person responsible for the authentication can advantageously check the identity of the user by comparing for example the name of the user communicated by this one or his/her identity paper to the name of that user present on the form, if it is present. That scenario is particularly interesting to authenticate for example a person wishing to benefit from a booking or a discount within a hotel, for instance.
That form can advantageously permit to update user information.

In the case of a mobile terminal, two ways to operate are possible:
First the person responsible for the authentication can simply send, thanks to a specific number corresponding to the regarded campaign, to the campaign manager with code an SMS message type, containing one of the elements that identifies the user as well as his/her received code. Depending on the result of that process, an SMS notification confirms or infirms the validity of the unique code.
Secondly, the person responsible for the authentication can use a WAP or GPRS or UMTS mobile terminal to access to a dedicated Internet page, under an adapted format (for instance WML) linked to the campaign manager with code where there can appear a form to be filled in with at least one of the elements that identifies the user, and with the code received by the user. Then the campaign manager with code processes that request by checking, in the database that contains specific information of the campaign, that the code actually corresponds to a unique triplet (user, campaign, product/service), that is to say that a given campaign for a given product/service exists for the regarded user. Depending on the result of that process, a notification steming from a server appropriate to the used terminal (WAP server for instance) confirms or infirms the validity of the unique code.

In that second case, by analogy with the case of a terminal connected to the Internet network, many advantages exist:
Given the fact that the form displayable on that type of mobile terminal can contain all available information of the user associated to the code, the person responsible for the authentication can advantageously check the identity of the user by comparing for example the name of the user communicated by this one or his/her identity paper to the name of that user present on the form, if it is present. That scenario is particularly interesting to authenticate for example a person wishing to benefit from a booking or a discount within a hotel, for instance.
That form can also advantageously permit to update user information.

In the case of an optic reader, concerning the bar code that can identify a unique triplet, the user can present that bar code to the person responsible for the authentication on a paper steming from for example the printing of that bar code previously sent to his/her electronic mailbox.

Depending on the support on which is the bar code, the person responsible for the authentication can operate that step as following:

In the case where the regarded bar code is on a paper, the person responsible for the authentication approaches the optic reader from that paper to scan the bar code. The result of that scanning is first transmitted to the computer to which the optic reader is connected, then sent to the campaign manager with code. The campaign manager with code processes that request by checking, in the database that contains specific information of the campaign, that the code actually corresponds to a unique triplet (user, campaign, product/service), that is to say that a given campaign for a given product/service exists for the regarded user. Depending on the result of that process, a code validity confirmation or information notification is transmitted to that computer.

According to one particularity of the invention, that authentication step can also be operated by the reading of a bar code transmitted over a mobile terminal such as for instance a mobile phone or a digital personal assistant, with an optic reader that scans the screen of that terminal. The result of that scanning can then be processed as in the case of a bar code authenticated from a paper support.

According to another particularity of the invention, this authentication step can also be operated by the reading of a bar code transmitted over a terminal connected to the Internet network, such as a personal computer, with an optic reader that scans the screen of that terminal. The result of that scanning can then be processed as in the case of a bar code authenticated from a paper support.

The authentication of a user with an optic reader, particularly when the information enabling to identify the user as unique is a bar code, can be operated with the same processes as described in the three previous paragraphs.

According to another particularity of the invention, the authentication by a person responsible for that step can also be operated from an interactive terminal. That interactive terminal, connected to the campaign manager with code can be for example present in a building (store, selling point . . . ) of the company for which the campaign is carried out. That interactive terminal is able to authenticate one of the elements that identifies the user and a unique code corresponding to a unique triplet, and to transmit the result of that authentication to the campaign manager with code, that confirms or infirms the validity of the unique code directly on the interactive terminal.

According to another particularity of the invention, the authentication can also be carried out by the user himself/herself. That process of self authentication till the confirmation or information of the unique code validity can be the same as the one in the case of an authentication carried out by another person, no matter the previously described authentication systems. One difference can however be in the fact that instead of resorting to a dedicated access, the user may resort to a user access.

According to another particularity of the invention, the authentication of the user and the unique triplet can also be carried out from a digital terminal connected to a digital TV broadcasting network. In that case, advantageously, the authentication can be carried out directly by the user, who fills in a form with at least one of the elements that identifies him/her and his/her received code. The entered data are then sent by the digital TV broadcasting network to the campaign manager with code. Then the campaign manager with code processes that request by checking, in the database that contains specific information of the campaign, that the code actually corresponds to a unique triplet (user, campaign, product/service), that is to say that a given campaign for a given product/service exists for the regarded user in the respect of conditions of the campaign. Depending on the result of that process, a notification that confirms or infirms the validity of the unique code is sent to the regarded digital terminal.

According to another particularity of the invention, the authentication of the user and the unique triplet can also be carried out from a digital terminal connected to a digital radio broadcasting network. In that case, advantageously, the authentication can be carried out directly by the user, who fills in a form with at least one of the elements that identifies him/her and his/her received code. Entered data are then sent by the digital radio broadcasting network to the campaign manager with code. Then the campaign manager with code processes that request by checking, in the database that contains specific information of the campaign, that the code actually corresponds to a unique triplet (user, campaign, product/service), that is to say that a given campaign for a given product/service exists for the regarded user in the respect of conditions of the campaign. Depending on the result of that process, a notification that confirms or infirms the validity of the unique code is sent to the regarded digital terminal.

According to another particularity of the invention, in the case the information enabling to identify as unique each user is a biometrics identification element, such as the fingerprint, the hand geometry, the face geometry, the voice, the iris, the retina, or the dynamic signature, and the code authentication is preceded by a user authentication, then the user authentication can be operated by systems of capture and process of morphological or biometrics element(s). This information is then sent to the campaign manager with code, which processes that request by checking, in the database that contains specific information of the campaign, that analyzed element actually corresponds to a specific user.

According to another particularity of the invention, the authentication with an interactive terminal, whether it is carried out by a person responsible for that step or by the user himself/herself, enables to print a paper coupon that contains at least the unique code corresponding to the unique triplet, and possibly the values and details associated to each of the three parameters of that unique triplet, that is to say the parameter user, the parameter product/service and the parameter campaign.

Thus, if for example, the coupon concerns a discount on a next purchase, the regarded user can present that coupon to an hostess or a cashier, for example, who will not have to carry out the tasks of identification and authentication (because already carried out by the user and confirmed by the campaign manager with code) but who will be able to just focus on the exercise of that coupon.

The invention concerns also the system enabling to operate the step of the above described method, with all its variants.

The step of codes exercise enabling to identify each unique triplet made up of the information concerning the targeted user, the considered campaign, and the product/service, consists in making the user of the campaign benefit from the object of the campaign, by resorting to various means of exercise, following the positive result of the step of authentication described above, when it takes place, and in the respect of conditions of the campaign, configured within the campaign manager with code.

The codes exercise can be performed by various means such as:
a voice server
a terminal connected to the Internet network
a mobile terminal
an interactive terminal
an optic reader
a terminal connected to a digital TV broadcasting network
a terminal connected to a digital radio broadcasting network

Two possibilities can be distinguished.

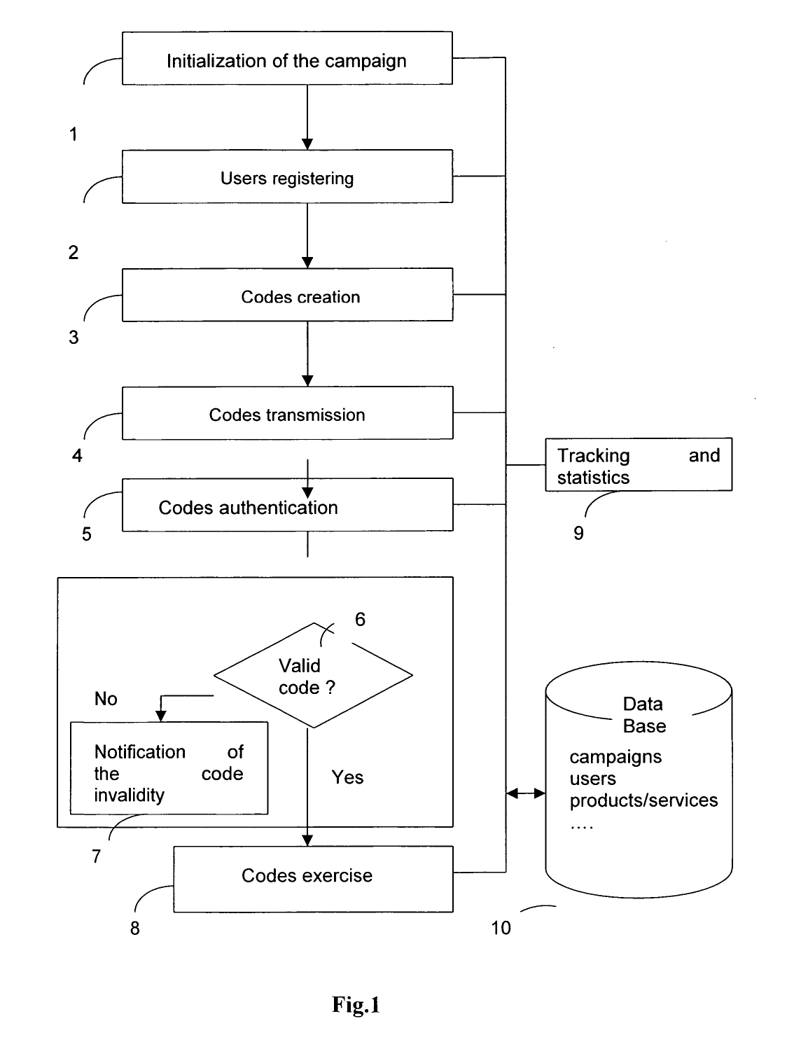

In case the authentication was performed by a person different from the user:
If the authentication was carried out by a voice server, then the voice server can propose by voice messages to perform the transaction. For example, the voice server can propose the hostess of a store, for example, a message such as “to exercise this discount, press button 1. Otherwise press button 2.” That hostess can then, in that example, sell the product in question by applying the discount.
If the authentication was carried out by a terminal connected to the Internet network, and for example, the code exercise relates to a commercial transaction, then the hostess, for example, can, for example, click on tabs containing messages such as “operate the transaction” or “cancel the transaction”. Advantageously, those tabs can be present on the same Web form which enabled the code authentication, in case that authentication was carried out by a terminal connected to the Internet network.
If the authentication was carried out by a mobile terminal with SMS type messages, then the SMS notification of the code authentication can also contain a proposal to exercise the code, for example, such as “to operate the transaction, return a SMS whose content is the FIG. 1”.
If the authentication was carried out by, for instance, a WAP, or GRPS, or UMTS mobile terminal, then the hostess can, for example, click on tabs containing messages such as “operate the transaction” or “cancel the transaction”. Advantageously, those tabs can be present on the same Web form of the Internet page which enabled the code authentication, in case that authentication was carried out by for instance a WAP, or GRPS, or UMTS mobile terminal.
If the authentication was carried out by an optic reader, that is to say that the result of that reading is, for example, first transmitted to the computer terminal to which the optic reader is connected, then sent by that computer terminal to the campaign manager with code, then preferably, it is possible to consider that the different processes of exercise of that bar code are identical to those carried out when the authentication was performed by a terminal connected to the Internet network.

The campaign manager with code updates, during all the steps and phases of the campaign, the different information, no matter the means used to communicate that information (voice server, terminal connected to the Internet network, mobile terminal with SMS type messages, WAP or GPRS or UMTS mobile terminal . . . ).

Therefore it is possible to start a step on a given system, and to continue the following step on another system. For example, it is possible to start the code authentication and/or code exercise phases on a given mean, and to continue those phases on another mean (for example to start the authentication by resorting to a mobile terminal with SMS type messages, and to continue that authentication with a terminal connected to the Internet network, or with a voice server).

In case the authentication was performed by the user himself/herself (such a situation is in particular possible for a company that wishes to carry out a campaign without having to intervene itself during the phase of authentication), the codes exercise can be performed with the same systems and according to the operating mode as the ones in case the authentication was performed by a person other than the user.

In accordance with one particularity of the invention, advantageously, the user can exercise his/her code directly from a digital terminal connected to a digital TV broadcasting network. In that case, if for example, the code exercise relates to a commercial transaction, then the user can, for example, click on tabs containing messages such as “operate the transaction” or “cancel the transaction”. Advantageously, those tabs can be present on the same form which enabled the code authentication, in case that authentication was carried out by a digital terminal connected to a digital TV broadcasting network.

In accordance with another particularity of the invention, advantageously, the user can exercise his/her code directly from a terminal connected to a digital radio broadcasting network, as for example a digital radio set. In that case, if for example, the code exercise relates to a commercial transaction, then the user can, for example, press on the keys of the digital radio set corresponding to messages such as “operate the transaction” or “cancel the transaction”.

In accordance with another particularity of the invention, it is possible to operate a coupling between different types of terminals and systems. That means that in a message sent on a type of terminal, it can be proposed to move to the following step of the campaign (step of authentication) on another type of terminal. For example, the sending of a text type message on a WAP mobile terminal can contain a hypertext link, in a manner that by activating that latter the user can access to a Web page to carry out, for example, his/her authentication. Another example can consist in the sending of a SMS type message that contains the telephone number of a voice server or of a call center, so that it is possible to call that voice server or that call center, and to move to the following step of the campaign.

The campaign manager with code can grant or refuse the code exercise by the processes described previously, according to the proper configured conditions of any campaign. For example, a user, who would wish to exercise his/her code beyond the end date of the campaign, if it exists, or more times the campaign allows him/her, would be alerted to the impossibility to carry out such an operation, by the campaign manager with code, over one of the codes exercise systems

By convention, such an operation that makes impossible the code exercise as soon as the proper configured conditions of any campaign are not met, is called “the code deactivation”.

According to an advantageous embodiment of the present invention, the method comprises moreover a code deactivation function by the campaign manager with code. This function can work as described hereafter:
to prevent a user from exercising his/her code beyond the end date of the campaign, if this date exists, the campaign manager with code can include in the transmitted message a program able to deactivate the regarded code when the end date of the campaign is reached, by making it for instance unreadable or inaudible.
to prevent a user from exercising his /her code more than the number of times the campaign allows him/her, the campaign manager with code can send, when the maximum number of times is reached, to the user a new message that includes a program able to deactivate the transmitted code, by making it for instance unreadable or inaudible.

The invention also relates to the system enabling to implement the function of the method, as described above, with all its variants.

The step of tracking and statistics, if it takes place, consists in tracking, that is to say in knowing in which step of the campaign are at least the unique codes associated to the unique triplets (step of creating, step of transmission, . . . ), in generating a set of statistics, and in displaying those statistics on various media. That step is carried out in the respect of conditions of the campaign, configured within the campaign manager with code.

Those operations can be carried out real time.

Tracking the codes real time consists in being able to know constantly, for any campaign, in which step of the campaign are at least the unique codes associated to the unique triplets, therefore in being able to know constantly the state of those triplets.

Concretely, that real time tracking is carried out as hereafter: the campaign manager with code scans constantly in which step of the campaign all the codes are, and fills in a table of the database which contains the result of those requests. Besides, the campaign manager with code updates real time that table.

Before generating, real time or not, statistics related to any campaign, those ones must have been defined.

Advantageously, several types of statistics can be defined, as for example, and not restrictively:
statistics related to the good execution of the campaign
statistics enabling to measure the effectiveness of the campaign

As regards the statistics related to the good execution of the campaign, those ones can, for example, indicate, real time, for a given campaign, the number of codes present at any step of the campaign (step of codes creating, codes transmission, codes authentication, codes exercise.)

As regards the statistics enabling to measure the effectiveness of the campaign, those ones can, for instance, indicate, real time, for a considered campaign, the various return rates of the campaign (for example, the transformation rate of a campaign, which can be defined as the result of the number of exercised codes divided by the number of created codes).

Once statistics are defined, they can be generated as follows:

Constantly, the campaign manager with code scans first in the database containing the specific data of the campaign, the various information it needs, and processes those ones by carrying out the necessary operations, on the basis of conditions of the campaign and definitions of the wished statistics, configured within the campaign during the initialization phase of the campaign, and updates that database with the results of those operations.

For example, to generate the transformation rate of a campaign, the campaign manager with code first scans in the database containing the specific data of the campaign, the information of the number of exercised codes and the one concerning the number of created codes, and carries out the regarded division, and updates the database with the result of that operation.

In accordance with one particularity of the invention, the statistics generated by the campaign manager with code can be displayed, real time or not, in various forms and from various systems and terminals.

The various systems from which it is possible to display, real time or not, those statistics can be:
a voice server
a terminal connected to the Internet network
a mobile terminal
a terminal connected to a digital TV broadcasting network
a terminal connected to a digital radio broadcasting network

In the case of a voice server, any person allowed to access to those statistics, for instance the persons responsible for the society for which the campaign is carried out, can query a voice server connected to the campaign manager with code, through a dedicated access. The campaign manager with code then processes this query of the voice server by scanning in the table of statistics the data to be transmitted vocally by the voice server.

In the case of a terminal connected to the Internet network, any person allowed to access to those statistics, can access to a Web page connected to the campaign manager with code, where those statistics appear under the form, for example, of figures tables or graphs.

In the case of a mobile terminal, advantageously, any person allowed to access to those statistics, and having a mobile terminal, for example, a WAP or GPRS or UMTS mobile, can access to a dedicated Internet Web page, under a format adapted to the type of terminal (for instance WML format), connected to the campaign manager with code, and accesses to those statistics, where those statistics appear under the form, for example, of figures tables or graphs.

In the case of a terminal connected to a digital TV broadcasting network, any person allowed to access to those statistics, can access to a dedicated screen page connected to the campaign manager with code, where those statistics appear under the form, for example, of figures tables or graphs.

In the case of a terminal connected to a digital radio broadcasting network, as for example a digital radio set, any person allowed to access to those statistics, can query from his/her digital radio set a station connected to the campaign manager with code, through a dedicated access. The campaign manager with code then processes that query by scanning in the table of statistics the data to be transmitted to the digital radio set.

In the case of a mobile terminal, it is also possible to access to the various statistics of a campaign, in a dedicated way, for example by using a specific SMS or MMS type message, sent to a specific number. The campaign manager with code processes that query, and send back those statistics by using SMS or MMS type messages, under the form of, for example, figures, figures tables and pictures which can represent a statistics evolution curve.

Those statistics can be sent to the allowed persons, over frequencies and on systems they can configure. The statistics can be transmitted, for instance, by e-mail message on their electronic mailbox, or on their mobile terminal, by a voice message on their fix and mobile telephone terminals, or by an SMS or MMS type message on their mobile terminal.

The invention concerns also the system enabling to implement the step of the method as described above with all its variants.

It may exist campaigns aiming simply at giving the benefit of the product/service to users, in the respect of certain conditions of exercise configured within the campaign manager with code, without having registered those users beforehand. For example, it may be the case with broadcasting type campaign, carried out, for instance, on the radio broadcasting relay systems.

Under the term “broadcasting campaign”, the present invention means a campaign where messages are transmitted or broadcast towards a given geographical area, the receiving field, through given network(s), as for example a radio broadcasting relay system, so that the persons present in that receiving field and having a receiving system appropriate with that network, can receive those messages.

In the case of such campaigns, since the “user” parameter is not known yet, the modelling of campaigns using unique triplets, described at the beginning of the invention, shifts to a modelling of campaigns using pairs, identical or not, having the form (value of the product/service parameter, value of the campaign parameter). Those pairs can be identical in case, for example, a commercial brand offers to make potential users, not previously identified, benefit from a same product/service within a same campaign.

The present invention models such a campaign in a process of steps which can be the same one as those described in the case of the unique triplets, and through which evolve pairs, which are identical or not, and having the form (value of the product/service parameter, value of the campaign parameter), and to which are associated codes, identical or not, in such a manner that to any pair corresponds a code, which is unique or not.

Those created codes can be transmitted by various systems enabling a transmission of information, for example, under the broadcast mode, such as:
radio broadcasting relay systems or digital radio broadcasting networks, where for instance on a given frequency, a advertising sends a message as well as a code enabling the users who have knowledge of it to profit from the object of the campaign
TV broadcasting relay systems or digital TV broadcasting networks
mobile telecommunication networks

In accordance with one particularity of the invention, those codes can be transmitted to the potential users of the campaign, by being directly present on various information media such as:
a bill
a newspaper or magazine
an advertisement during a cinematography projection
an advertisement on the Internet network, which can have or not the type of an advertising banner

In that type of campaign simply aiming at making users benefit from a product/service, without previous users registering, advantageously the step of users registering can be carried out during the step of codes authentication, which have been transmitted by the means described above, if that step of codes authentication takes place, or during the step of exercise of those codes. In that case, the possible values of the “user” parameter, since they are not unknown anymore, it is then possible to change those pairs, identical or not, into unique triplets as described at the beginning of the invention. A replication of the aforementioned pairs before their transformation into unique triplets can be carried out and stored.

The invention concerns also the system enabling to implement the method that changes the pairs, identical or not, having the form (value of the product/service parameter, value of the campaign parameter), into unique triplets, having the form (value of the user parameter, value of the product/service parameter, value of the campaign parameter), with all its variants.

It may also exist campaigns using more parameters than those present in the unique pairs or the unique triplets, such as:
the parameter giving information about the location of campaign (a selling point)
or the parameter giving information about when the campaign shall be carried out (date).

In the case of such campaigns, the modelling of campaigns using unique triplets, described at the beginning of the invention, shifts to a modelling of campaigns using a certain integer of unique groups, called in the present invention “multiplets”, composed of the value of each of the N parameters (N being the number of parameters used in the modeling of the campaign). For instance, each of those unique groups can have the following form (value of the “user parameter”, value of the “product/service parameter”, value of the “campaign parameter”, value of the “location parameter”, value of the “date parameter”, value of the “. . . ” parameter, . . . ).

The present invention models such campaigns in a process of steps which can be the same as the ones described in the case of the unique triplets. Analogicaly a unique code is associated with each of those unique multiplet.

A preferred embodiment of the present invention will be described hereafter, as a non restrictive example, with reference to the drawings. It is to be understood that the invention is not limited to the specific embodiment or drawings so described. Rather, the scope of the invention is defined by the claims and includes equivalents thereof.

The embodiment of the present invention described hereafter is a campaign, carried out for the account of a commercial company, which for example offers to benefit from a discount on the purchasing price of a given product on given selling points.

According to FIG. 1, the campaign is initially configured in the step of initialization of the campaign 1. These data of configuration, as for example how long the campaign lasts are stored in the database 10.

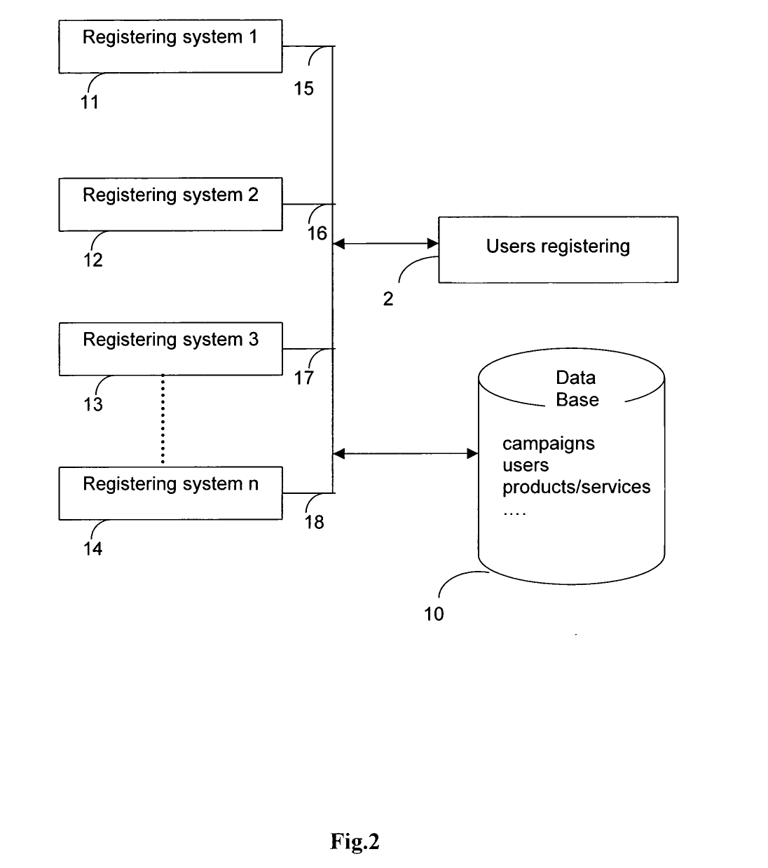

The present method and system comprise a step of users registering of the campaign 2, according to FIG. 2, aiming at registering within the campaign manager with code in the database 10, the explicit agreement of the users of the campaign, if it has not been obtained before, as well as at least an address of the receiving system of the message of the campaign, and at least an information enabling to identify as unique each user.

It can be noticed, for example, that in case the address of the receiving system of the message of the campaign is a mobile telephone number, or an e-mail address, then that address is also an information enabling to identify as unique each user. People interested by the aforementioned campaign can register themselves as users of the campaign, by various registering systems, which can be according to FIG. 2:
a voice server, registering system 11, connected to the fix telecommunication network 15
a terminal computer, registering system 12, connected to the Internet network 16
a mobile terminal, registering system 13, connected to the mobile telecommunication network 17.

During that registering, users have the possibility to specify the address of the system on which they wish to receive the message(s) of the campaign. For instance, some users specify a mobile telephone number, others an e-mail address of Internet type, others still an e-mail address of their mobile telephone of WAP type.

The present method and system comprise besides a step of codes creation 3, according to FIG. 1, aiming at creating by the campaign manager with code a unique code for each of the triplets (user, product/service, campaign). Those various codes are stored in the database 10. In the present embodiment, that code is, for example, a numerical code.

The present method and system comprise besides a step of codes transmission 4, according to FIG. 1, aiming at transmitting to users, on the receiving systems, specified beforehand, the message indicating the object of the campaign and containing the transmitted unique codes.

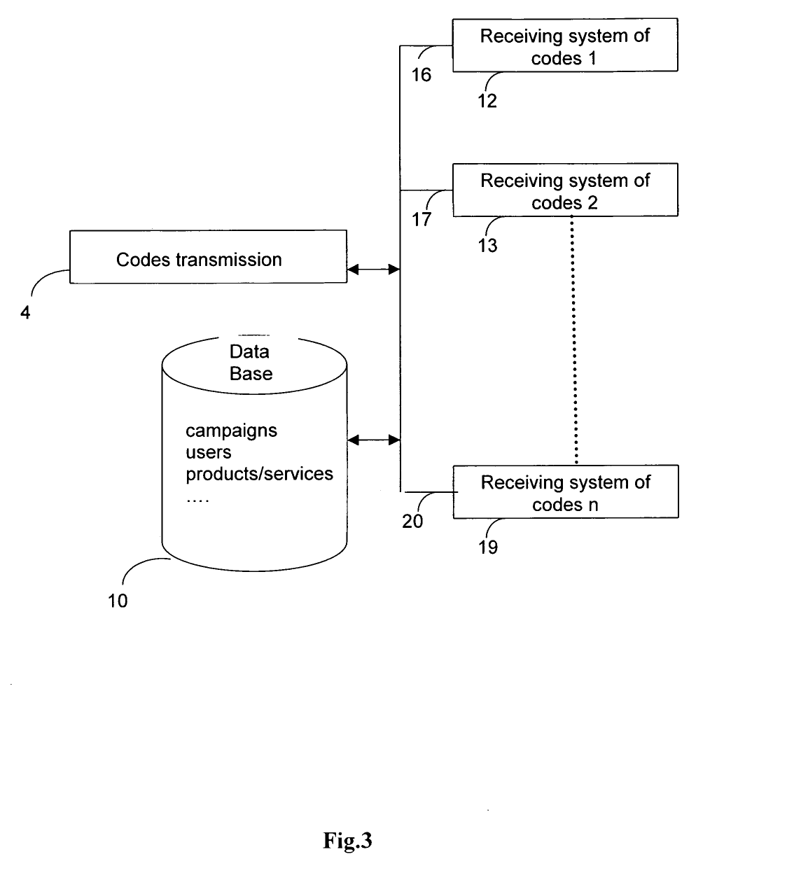

According to FIG. 3, for example, users receive according to the specified address of the receiving system, that message under the form for example:
an Internet e-mail on their terminal computer 12 connected to the Internet network 16
an SMS on their mobile terminal 13 through the mobile telecommunication network 17
an e-mail on their mobile terminal of WAP type 13 through the mobile telecommunication network 17.

The present method and system comprise, besides, a step of codes authentication 5, according to FIG. 1, aiming at identifying the codes, and therefore at identifying the unique triplets to which they correspond, at checking the valid feature of those codes 6, and at notifying the possible invalid feature 7 of those codes.

The users who received the messages inviting them to benefit from the object of the campaign, and containing those codes, can go on the selling point taking part in the campaign. There, they can be helped by a person, who for example, before making them benefit from the regarded discount, carries out that operation of authentication. The users show that person their code. For example, the user who received his/her code under the form of a SMS type message, can directly show that SMS. The person in charge of the operation of codes authentication uses, for example, a computer terminal connected to the Internet network, and accesses to a dedicated Web page, connected to the campaign manager with code.

On that Web page, can appear a form that person fills with at least one of the data that identifies the user, stored in the database 10 during the step of users registering, as well as with the code received by the user.

According to FIG. 1, the campaign manager with code processes then that query by checking, in the database 10 that the code is valid 6, that is to say the user thus filled is allowed to benefit from the object of the aforementioned campaign.

In case that code is not valid, a notification of the code invalidity 7, managed by the campaign manager with code, appears of that Web page.

The present method and system comprise, besides, a step of codes exercise 8, according to FIG. 1, for the codes whose the valid feature was checked during the preceding step of codes authentication. That step of codes exercise aims at carrying out the object of the campaign, that is to say in the present embodiment at being able to benefit from a discount on the purchase of a given product.

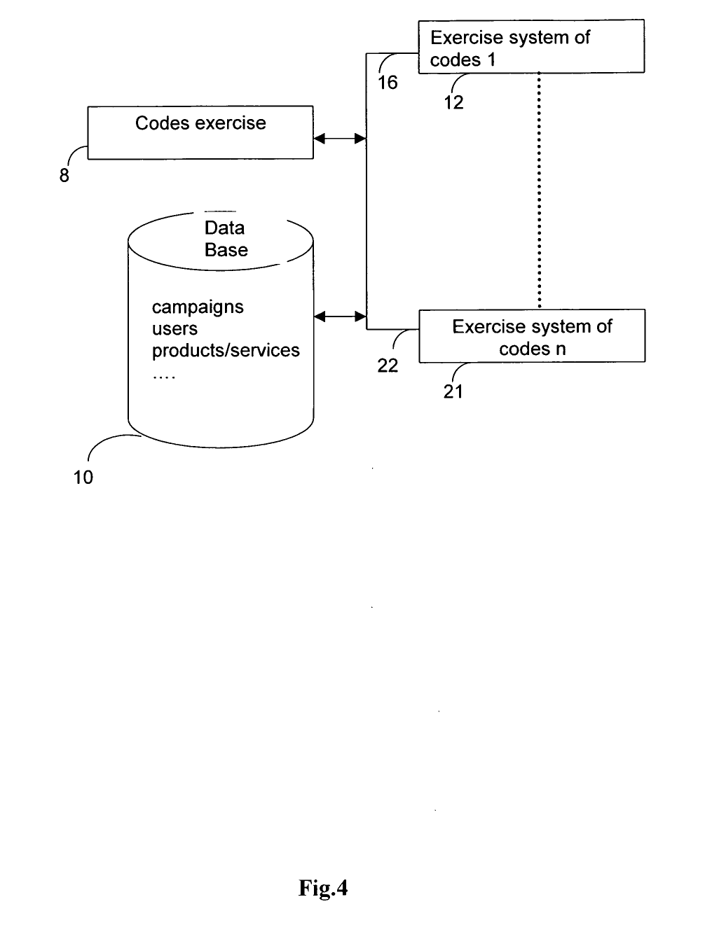

For example, the person who carries out the codes authentication, can from the same dedicated Web page, exercise those codes by clicking on the ad hoc tabs. According to FIG. 4, that operation of codes exercise was carried out from a terminal computer 12 connected to the Internet network 16.

The present method and system comprise besides a step enabling to track real time the codes and to generate real time a set of statistics 9, according to FIG. 1.

For example, if it was configured to supply as statistic the transformation rate of the campaign, the campaign manager with code scans in the database 10, the information of the number of exercised codes and the one concerning the number of created codes, then carries out the rate operation, and stores the result of that operation in the database 10.

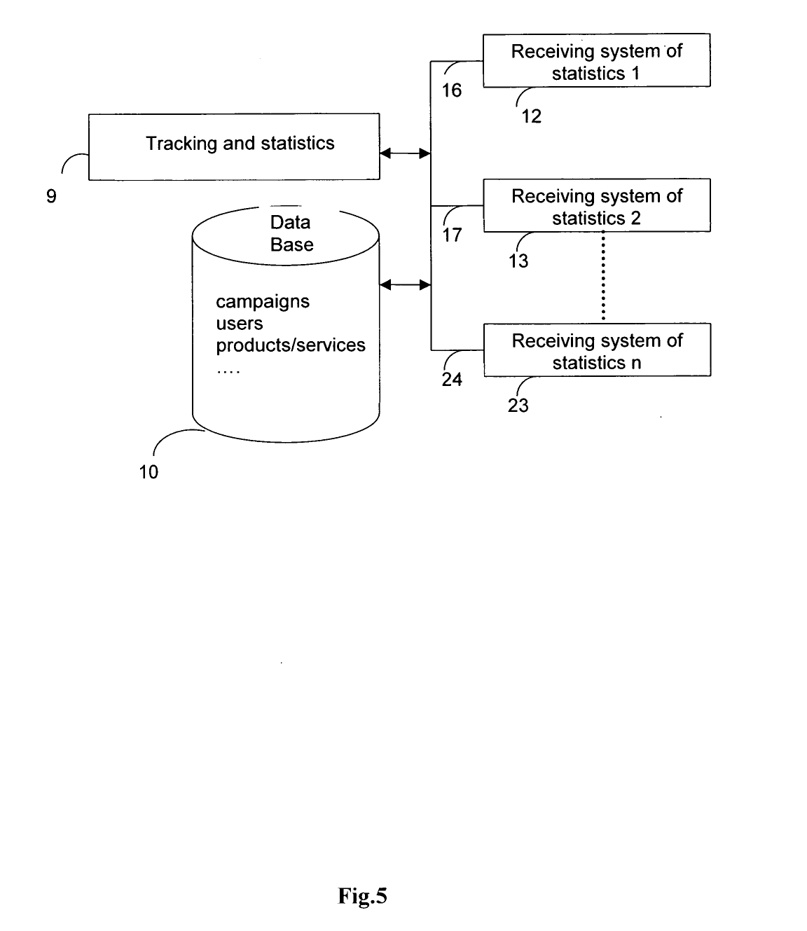

The statistics generated by the campaign manager with code can be displayed real time under various forms (charts, figures . . . ) and from various systems and terminals. According to FIG. 5, in the present embodiment, the transformation rate of the campaign can be displayed from a terminal computer 12 connected to the Internet network 16, as well as from a mobile terminal of WAP type 13 connected to the mobile telecommunication network 17.

Other examples of extreme relevant statistics that can be real time calculated and real time displayed under various forms and from various systems and terminals, and that can be drawed by the present invention include for instance:
The turnover generated by the campaign equivalent to:
   the price of the product/service of the campaign multiplicated by the number of exercised codes.
The business margins of the campaign equivalent to
   the turnover generated by the campaign to which we deduce the cost of the campaign. Therefore, thanks to this invention, it is for example possible to calculate and display real time how many American dollars or European euro (or any currency type) are generated by the campaign for each American dollar or European euro (or any currency type) invested.
Relevant information as regards the behaviour of the people targeted by the campaign, and on the basis of that, to adapt next campaigns possibly real time. Indeed, one of the dreams of any sales and marketing Manager of any company (especially those dealing in the business to consumers industry) is to know real time exactly among the possible milions of people that have targeted in by a specific campaign which user did what, when, and spent how much money in the regarded campaign. The present invention, thanks to an end to end real time tracking answers those questions, and enable therefore what is called in marketing science a complete knowledge of the client, enabling a targeted marketing, and optimising futures campaigns or even adapting real time the campaign. Indeed, for example, we can imagine, for instance, that on the basis of the real time transformation rate of the campaign (defined above), a specific message or a new campaign is automaticly operated for the users who did not excercice their code after a certain amount of time, or for those who exerciced it very fast.

1. A method of campaign management with code to define, to plan, to carry out, and to track, possibly real time, every phases and steps any multimedia campaign can have, characterized by the fact that it comprises a step of initialization of the campaign consisting in updating in a database (10) the parameters related to the campaign, and a step of registering by the users interested by the aforementioned campaign by resorting to various registering systems, this step of registering consisting in providing with at least one information corresponding to the address(es) of receiving system(s) of these users, and one information, for instance a digital data, enabling to identify each user as unique, and a step of codes creation consisting in an operation which creates and associates a unique code with each unique triplet having the form (value of X, value of Y, value of Z) where:
X corresponds to the parameter “campaign user”,
Y corresponds to the parameter “product/service”,
Z corresponds to the parameter “campaign”, where Z can be a function of X and Y,
this code having the feature of being able to be tracked end to end and real time, no matter the types of networks and terminals on which the campaign is carried out, the present method also comprises an operation of storage of this unique code in a database (10), and a step of codes transmission consisting in sending to the users by various transmission means, on their various receiving system(s), a message composed of at least one code such as the one created in the step of codes creation, and a step of codes exercise consisting in carrying out and validating the object of the campaign, by resorting to various exercise means connected to the campaign manager with code, in the respect of the conditions of the campaign, configured within the campaign manager with code, the present method comprises as well steps consisting in updating in a database (10), during all the phases and steps of the campaign, the various data, no matter the means used to communicate these data, the method being also characterized by the fact that the exchanged digital data are carried out over different media, based on different communication networks, notably the fix and mobile telecommunication networks, the Internet network, and the different broadcasting networks such as the radio broadcasting and the TV broadcasting networks.

2. A method according to claim 1, characterized by the fact that it comprises a step of authentication, possibly real time, of the unique codes associated with each unique triplet consisting in providing the campaign manager with code, by means of terminals and systems connected to this latter, at least with the unique codes enabling to identify each unique triplet, and in carrying out the three following phases:
the identification of at least the codes enabling to identify each unique triplet
the checking of the valid/non valid feature of those codes, in the respect of parameterized conditions for the regarded campaign,
the notification of the valid/non valid feature of those codes in the respect of parameterized conditions for the regarded campaign.

3. A method according to claim 1, characterized by the fact that it comprises a step of tracking, possibly real time, of the unique codes associated with each unique triplet consisting in finding out in a database (10) of the campaign manager with code in which step of the campaign are the unique codes associated with the unique triplets, and in updating the database (10) with the result of this retrieval.

4. A method according to claim 1, characterized by the fact that the users registering is carried out by means of:
a voice server
a terminal connected to the Internet network
a mobile terminal
an interactive terminal
a system of capture and processing of morphological or biometrics elements coupled to one of the above systems
a terminal connected to a digital TV broadcasting network
a terminal connected to a digital radio broadcasting network

5. A method according to the claim 4, characterized by the fact that the users choose and modify at any moment, by resorting to one of the registering systems, the receiving system on which they wish to receive the messages of the campaigns.

6. A method according to claim 1, characterized by the fact that the unique code enabling to identify any unique triplet made up of the information concerning the targeted user, the considered campaign, and the proposed product/service, is:
any unique alphanumeric code
any unique bar code
any unique picture
any unique sound suite
any unique moving pictures suite
any unique combination of the above elements

7. A method according to claim 1, characterized by the fact that the generation of the unique codes, whether they are codes enabling to identify as unique each triplet, or the ones enabling to identify as unique each user, or the ones enabling to identify as unique each campaign, or the ones enabling to identify as unique each product/service, is carried out by a random function of generation of alphanumeric codes.

8. A method according to claim 1, characterized by the fact that it comprises besides a step which consists in making sure that any code created by the campaign manager with code is not identical to any existing generated code of the same nature, if necessary, as many generations of codes are performed by the campaign manager with code until obtaining a different code from any existing generated code of the same nature.

9. A method according to claim 1, characterized by the fact that the codes transmission is accompanied:
by a text message
by a picture
by a sound suite, corresponding for example to a piece of music such as the jingle of a brandmark
by a succession of moving pictures, corresponding for example to a video clip or a cartoon
by possible others codes, generated by the campaign manager, enabling to identify as unique the targeted user, or the considered campaign, or the concerned product/service.

10. A method according to claim 1, characterized by the fact that the transmitted codes are received on the following receiving systems:
a mobile terminal
a terminal connected to the fix telecommunication network
a terminal connected to the Internet
a digital radio set
a digital television set
an interactive terminal.

11. A method according to claim 1, characterized by the fact that the transmission of MMS type messages containing codes over the mobile telecommunication network is always accompanied of, on the one hand, a transmission of the same message on the Internet electronic or mobile electronic mailbox of the user, in case the campaign manager with code has the electronic address of the user, and/or on a dedicated Web page for this purpose, and on the other hand, within that MMS, of a text part inviting the user of the campaign to consult that message on his/her electronic mailbox and/or on the dedicated Web page.

12. A method according to claim 2, characterized by the fact that the codes authentication is preceded by a step of users authentication consisting in providing the campaign manager with code with one of the elements that identify as unique the user, by resorting to authentication systems, and in checking the valid feature of this data.

13. A method according to claim 2, characterized by the fact that the codes authentication or the users authentication is carried out by the following systems connected to the campaign manager with code:
a voice server
a terminal connected to the Internet
a mobile terminal
an interactive terminal
an optic reader
a voice recognition system
a system of capture and processing of morphological or biometrics elements

14. A method according to claim 13 , characterized by the fact that an optic reader reads a bar code transmitted on a mobile terminal.

15. A method according to claim 13 , characterized by the fact that an optic reader reads a bar code transmitted on a terminal connected to the Internet.

16. A method according to claim 1, characterized by the fact that the codes exercise is carried out by:
a voice server
a terminal connected to the Internet
a mobile terminal
an optic reader
an interactive terminal
a terminal connected to a digital TV broadcasting network
a terminal connected to a digital radio broadcasting network.

17. A method according to claim 1, characterized by the fact that the transmitted message, containing at least the unique code associated with the unique triplet, includes a program having the effect to deactivate that code when the end date of the campaign is reached, by making it unreadable or inaudible.

18. A method according to claim 1, characterized by the fact that a message, different from the message containing at least the unique code associated with the unique triplet, includes a program having the effect to deactivate the code transmitted previously, when the maximum number of times it is possible to exercise the code is reached, by making it unreadable or inaudible.

19. A method according to claim 1, characterized by the fact that relevant statistics, such as the transformation rate of the campaign, the turnover generated by the campaign, the business margins of the campaign, the profitability of the campaign, or the ones linked to how the users react to the campaign, can be real time calculated and real time displayed under various forms and from various systems and terminals, enabling a complete knowledge of the client, potential basis to adapt real time the campaign, and to optimise next campaigns.

20. A method according to claim 1, characterized by the fact that all or some of the steps and operations described in claims 1 to 19 related to the method of campaign management with code associating unique codes with unique triplets, apply to the method associating codes with pairs having the form (value of the product/service parameter, value of the campaign parameter).
